(19) United States
(12) Patent Application Publication
(10) Pub. No.: US 2007/0168754 A1
(43) Pub. Date: Jul. 19, 2007

(54) Method and apparatus for ensuring writing integrity in mass storage systems

(75) Inventors: Ofir Zohar, Alfe-Menashe (IL); Haim Helman, Ramat-Gan (IL); Shemer Schwartz, Herzelia (IL); Efri Zeidner, Kiryat Mozkin (IL)

Correspondence Address: KATTEN MUCHIN ROSENMAN LLP, 575 MADISON AVENUE, NEW YORK, NY, 10022-2585, US

(73) Assignee: XIV LTD.

(21) Appl. No.: 11/311,563

(22) Filed: Dec. 19, 2005

(51) Int. Cl. G06F 11/00

(52) U.S. Cl. 714/42

(57) ABSTRACT

A method for ensuring integrity of a data portion written by a controller and stored on a disk drive is provided that includes, among other things, forming at least one queue of a plurality of verification tasks associated with the disk drive and executing at least one verification task associated with the data portion in accordance with the queue. The method also includes identifying each datum of the data portion as one of faulty and not faulty in accordance with the verification task. A data storage apparatus is provided. A device is provided that is adapted to execute a method for ensuring integrity of data written by a controller and stored on a disk drive. A computer-readable storage medium is provided that contains a set of instructions for a computer.

### FIELD OF THE INVENTION

The present invention relates generally to data storage systems, and specifically to actions taken to detect and correct data integrity problems related to write commands in such systems.

### BACKGROUND OF THE INVENTION

Mass storage systems implement several kinds of mechanisms in order to ensure continued data availability and integrity. A high percentage of data integrity problems in such systems are caused at the time, and as part, of the very act of writing data to the media. One approach typically used to overcome such problems is known as “Write-Read-Verify”.

Typically, whenever a host computer writes data to the system, this data is temporarily stored in cache and the command is immediately acknowledged, and thus the latency of the individual write command is shortened. The cache eventually writes the data into the permanent media. Under the “Write-Read-Verify” approach, this write transaction is immediately followed by a second transaction, whereby the cache reads the data just written and compares the result of this read transaction with the data originally written by the host and temporarily stored in cache. If the comparison shows that the data was not correctly written, the write transaction from cache to disk can be repeated until it is completed successfully.

The extra transactions incurred when following the “Write-Read-Verify” approach considerably increases the rate of internal activity within the storage system. In systems working under heavy workload activity, this increase may affect the system's overall performance.

There is therefore a need for procedures that ensure the integrity of data just written to the permanent media in mass storage systems, but which have a lower negative impact in the system's overall performance.

### SUMMARY OF THE INVENTION

In embodiments of the present invention, a data storage system comprises a group of mass storage devices which store respective data therein, the data being accessed by one or more hosts transmitting input/output (IO) requests to the storage system. The data is stored redundantly in the system, so that at least two mass storage devices each have a copy of the data. The IO requests comprise IO write requests, wherein data is written redundantly to at least two mass storage devices, and IO read requests, wherein data is read from one of the devices.

A method for ensuring integrity of a data portion written by a controller and stored on a disk drive is provided that includes, among other things, forming at least one queue of a plurality of verification tasks associated with the disk drive and executing at least one verification task associated with the data portion in accordance with the queue. The method also includes identifying each datum of the data portion as one of faulty and not faulty in accordance with the verification task.

The method may further include writing the data portion from a cache to the disk drive and repairing each datum identified as faulty.

The method may further include temporarily storing the data portion in a memory buffer. The memory buffer may be part of the disk controller or part of a cache memory of a storage system.

The method may further include erasing the data portion temporarily stored in the memory buffer after performing the verification task.

The repairing operation may include: taking no action; issuing a message to a user or to a system manager indicating that a fault has been identified; rewriting the data portion on the disk drive with the data portion temporarily stored in the memory buffer; and/or overwriting the data portion with a further data portion obtained from one or more alternative locations.

The method may further include defining the at least one verification task. The method verification task may include issuing a verify command for the data portion on the disk drive; reading the data portion from the disk drive at the location where it was written; sending a read request to an alternative location for a corresponding data portion in a system in communication with the controller; comparing the data portion in the disk drive with the corresponding data portion in the alternative location; reading meta-data associated with the data portion and verifying data sanity in the data portion in accordance with the metadata; reading further meta-data associated with the corresponding data portion in the alternative location and verifying data sanity in the data portion in accordance with the further metadata; and/or comparing metadata associated with the data portion in the disk drive with the further metadata associated with the corresponding data portion in the alternative location.

The method may further include acknowledging the completion of the write request, and the verification task may be executed substantially after the acknowledging operation.

The queue may be formed according to a scheme of: first in first out (FIFO); last in first out (LIFO); last recently used (LRU); most recently used (MRU); and/or random access.

The method may further include managing the at least one queue. The queue may be managed by: performing the at least one verification task before a maximum time elapses since the verification task was added to the queue; performing the at least one verification task after a minimum time elapses since the verification task was added to the queue; performing the at least one verification task when the disk controller determines there is a low demand for high priority read/write tasks; performing the at least one verification task when the disk controller determines an optimal time is reached based on a system demand overview; performing the at least one verification task when the at least one queue is a maximal length; performing the at least one verification task when a time stamp for the verification task exceeds a maximal time; performing the at least one verification task when an average time to perform a plurality of performed verification tasks in the queue exceeds a maximal value; and/or performing each verification task a maximal value of the most recent verification task.

The identifying operation may include: inability to read the data portion from the disk drive; inability to read the data portion from the disk drive within a given time limit; disagreement between the data portion read and a corresponding data portion read from an alternative location; disagreement between metadata associated with the data portion and the data portion; disagreement between the metadata associated with the data portion and further metadata associated with the corresponding data portion from the alternative location; and/or disagreement between two or more data instances of the corresponding data portion from the alternative location.

A data storage apparatus is provided that includes a storage media adapted to store data, a source media adapted to read data, and a controller adapted to receive write commands, read data from the source media, and write data to the storage media. The controller is adapted to manage at least one queue of a plurality of verification tasks, each of the verification tasks associated with a data portion read from the source media and written to the storage media. The controller is adapted to execute each verification task associated with the data portion in accordance with the queue. The controller is adapted to identify each datum of the data portion as one of faulty and not faulty in accordance with the verification task.

The controller may be adapted to repair each datum identified as faulty.

A device is provided that is adapted to execute a method for ensuring integrity of data written by a controller and stored on a disk drive. The device includes a managing arrangement adapted to manage at least one queue associated with the disk drive, the queue including a plurality of verification tasks, each verification task being associated with a data portion of the data. The device further includes a performing arrangement adapted to perform each verification task in accordance with the queue and an identifying arrangement adapted to identify each datum of the data portion as one of faulty and not faulty in accordance with the verification task. The device also includes a repairing arrangement adapted to repair each datum identified as faulty.

A computer-readable storage medium is provided that contains a set of instructions for a computer. The set of instructions includes managing at least one queue associated with the disk drive, the queue including a plurality of verification tasks, each verification task being associated with a data portion. The set of instruction also includes performing the verification task associated with the data portion in accordance with the queue and identifying each datum of the data portion as one of faulty and not faulty in accordance with the verification task. The set of instruction further includes repairing each datum identified as faulty.

A method for ensuring integrity of a data portion written by a controller and stored on a disk drive is provided. The method includes flagging with at least one scrubbing flag at least one data partition of the disk drive and scanning the disk drive for the scrubbing flags. The method also includes assigning at least one verification task to the data partition flagged with the scrubbing flag and executing the verification task assigned to the data partition. The method further includes identifying each datum of the data portion as one of faulty and not faulty in accordance with the verification task.

The method may further include writing the data portion from a cache to the data partition and repairing each datum identified as faulty.

The scanning may be performed: at regular intervals of time; after writing a predetermined amount of data; and/or after writing a predetermined number of write operations.

The scrubbing flag may include a verification task indicator and the assigning operation may include reading the verification task indicator and assigning the verification task based on the verification task indicator.

The present invention will be more fully understood from the following detailed description of the embodiments thereof, taken together with the drawings, a brief description of which is given below.

### BRIEF DESCRIPTION OF THE DRAWINGS

FIG. 1 is an exemplary, schematic diagram of elements of a disk controller 20, in accordance with an embodiment of the present invention;

FIG. 2 is an exemplary, schematic diagram of a partition table 17, in accordance with an embodiment of the present invention;

FIG. 3 is a schematic diagram of a verification task queue, in accordance with an embodiment of the present invention; and

FIG. 4 is a schematic flowchart of an algorithm showing steps performed in a controller, in accordance with an embodiment of the present invention.

### DETAILED DESCRIPTION OF EMBODIMENTS

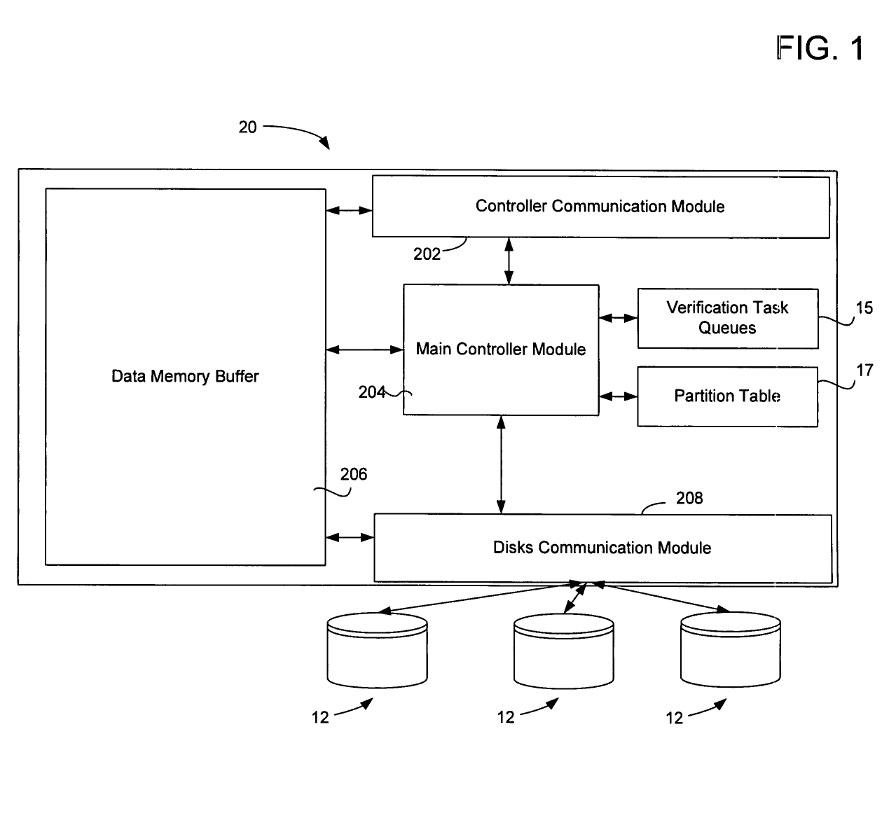

Reference is now made to FIG. 1, which is a schematic diagram of elements of a disk controller 20, in accordance with an embodiment of the present invention. The controller 20 may include a communication module 202 which may be adapted to enable communications between the controller 20 and other components of a storage system of which it may be a part. By way of example, in an embodiment of this invention a controller 20 may communicate via switches with caches in a storage system, with interfaces of a storage system, or with other disk controllers in a storage system. In fact, in embodiments of the present invention the disk controller may actually be part of a cache memory in a storage system. Communications with other components may include the receipt of service requests and the transmission of responses to the service requests, as well as the receipt and transmission of data. The controller 20 may further include a main controller module 204, adapted to manage the operation of the controller's various components and to fulfill the controller's various tasks. In addition the controller 20 may include a data memory buffer 206, used to store data within the controller 20. Further, the controller may include a disk communication module 208, operatively connected to the disks 12, and adapted to relay communications between the controller 20 and the disk 12 (in both directions). Disks 12 function as permanent media adapted to substantially permanently store data communicated to it by the controller. In embodiment of the present invention, alternative kinds of media may be used instead of disks, including, but not limited to, optical media or other kinds of magnetic media as known in the art. Controller 20 also contains a set of partition table 17 as well as a set of verification task queues 15, whose function is described below in greater detail.

In embodiments of the present invention, data is stored on disks 12 as data blocks which are in turn organized into sets of consecutive data blocks called “partitions”. Partitions are the basic data portions used to manage data transactions between the controller and the disks, and between the controller and other components of a storage system with which it may communicate, and the present invention describes a method to ensure the integrity of data associated with partitions. The terms “partition” and “data portions” are used herein equivalently and they may be freely interchanged throughout this document. It must be further pointed out that in an exemplary embodiment of the present invention, where the controller 20 is a component of a storage system, sequences of consecutive partitions may be taken to form the basic storage unit of the system, known as a logical unit (LU) . LUs are thus logical sequences of data blocks, each of which may be associated with a logical address (LA) . A partition may thus be defined as a range of consecutive blocks in an LU. In embodiment of the present invention partitions may be considered to be of equal size.

The controller may be adapted to receive data that is to be written into the disks and to retrieve data form the disk and communicate it to other components of a storage system that are requesting it. Whenever data is sent to the controller in order to be stored on disks, for instance if a data partition is sent to controller 20 in order to be stored in one of the disks 12 associated with it, the main controller module 204 may store the data associated with that partition in the data memory buffer 206 and it may at the same time create a corresponding entry in the partition table 17. This entry may be used to manage the partition lifecycle while it exists in one of the disks 12 associated with controller 20. The controller 20 may eventually transmit to the disks, via disk communication module 208, the data associated with the partition, and the data may be stored on the disk in a substantially permanent way.

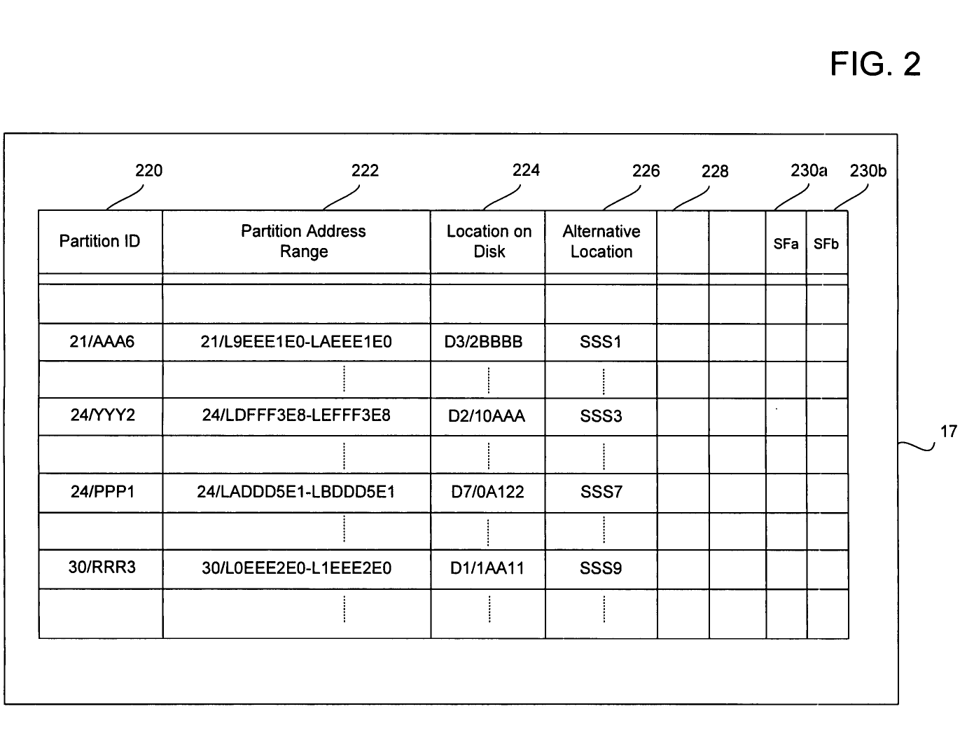

FIG. 2 is an exemplary, schematic diagram of a partition table 17, which may be part of controller 20 as described in FIG. 1 above, according to an embodiment of the present invention. Table 17 may comprise a column 220 where the ID of the partition may be written. In embodiments of the present invention a partition may be identified by its serial number within the LU to which it belongs. Thus for instance, entry 21/AAA6 may identify a partition whose serial number within LU 21 is AAA6. A column 222 in table 17 may indicate the range of logical blocks within the LU that are associated with this partition. A column 224 may list the physical location assigned to the partition on the disk. By way of example, the physical location listed in column 224 may be in the form DN/XXXXX, where DN indicates the specific disk 12, from among all disks 12 associated with this controller in which the partition is written, and XXXXX indicates the exact physical address of the partition on disk DN (for instance, “2BBBB”, “10AAA”, “0A122”, or “1AA11”).

In embodiments of the present invention, the storage system of which the controller is part may be a redundant storage system, namely, a system in which more than one physical copy of every logical partition is stored. Table 17 may contain a column 226 indicating an alternative location in the storage system where the second physical coy of the partition indicated in this entry is located.

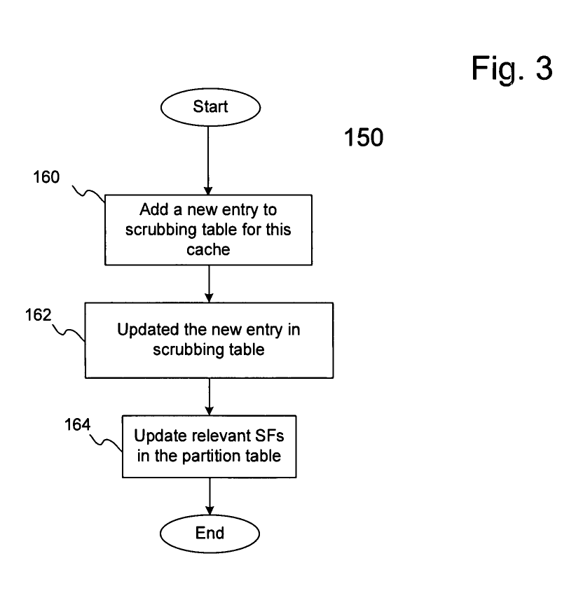

FIG. 3 is a schematic diagram of a verification task queue showing the flow in a controller's algorithm. The flow proceeds from the start to action 160, which indicates to add a new entry to a scrubbing table for this cache. From action 160, the flow proceeds to action 162, which indicates to update the new entry the scrubbing table. From action 162, the flow proceeds to action 164, which indicates to update the relevant scrubbing flags (SFs) in the partition table. SFs may indicate which of the various possible scrubbing processes is applied in the present situation. Thus, in the present embodiment, they may be removed. From action 164, the flow proceeds to the end.

In a conventional write-verify-read algorithm, a partition may be written into the disk and may continue to be stored in the cache. Then the cache may immediately try to read the partition that has just been written. If the read operation is successful, the algorithm ends. If it is not successful, the cache (or more generally the disk controller) may take the partition that is stored in the cache and write it again. The same verification by means of a read attempt may be performed again.

In an exemplary embodiment of the present invention, a write operation is performed and then the verify is performed only when it is convenient to the system in terms of overall system considerations, which is discussed in detail in the following discussion.

In FIG. 3, algorithm 150 may create a verification task which is later applied. Algorithm 150 may be performed each time that a partition is written into the disk. Sometimes the original write request that came from the host may involve less than a partition, for example a single block or several blocks. Write and read activities in the system may be performed in terms of partitions. Thus, if the host writes a single block, the cache may first read the entire partition from the disk and write the block onto the partition that has been read, and this modified partition may be the partition that will be then written back to the disk. Also the system may utilize a specific method of deciding when a partition that is write-pending (alternatively referred to as containing dirty data) will be written to the disk (or destaged) Destaging is a process whereby the cache writes to the disk data that is dirty, but it does so according to various considerations. The cache may perform this write operation when it considers that the time is ripe. This is part of the overall cache management routines in the system. When the time comes to write the partition to the disk, algorithm 150 may be implemented. Algorithm 150 may create a task and add it to the queue. The task identifies a partition that has been just written to the disk. The name of the partition is sufficient since the partition table exists and indicates where the data is written on the disk. The task also indicates where the data is now temporarily stored in cache and may also give a timestamp which may be of use in handling the queue at a later time. The task may also contain an indication of what kind of verification is expected. The exemplary verification task discussed above indicates to try and read the partition from the disk. Alternative verifications may include, for example: read and compare with the temporarily stored data; give the “verify” command instead of read command; read a CRC (cyclic redundancy check) of the partition and compare it with that of the stored data; and/or compare with the content of the data in its alternative location, assuming the data is redundantly stored in the system.

Thus, while in some exemplary embodiments the data may be kept in cache until the verification is completed, there are alternative verification modes that do not require keeping the data in cache until it has been verified. Therefore, there are various methods for implementing the system.

Therefore, the present invention provides a system with several options and for each task created a specific verification option is chosen. The system may determine that all of the tasks are of a certain type and then of another type, or choose at random what type of verification to assign to this task. In one exemplary method, one verification type is applied to all tasks.

Notice also that it is possible that the partition for which we are defining a verification task has already a verification task in the queue waiting to be performed. In this case, the existing verification tasks for this partition can be deleted when the new task for this partition is added to the queue (or alternatively, the new task may overwrite the existing one) and indeed the new data can be temporarily stored in the same place where the previous data for this partition was temporarily stored. One possibility to implement this is by adding a bit in the partition table that indicates that a partition has a verification task in the queue. If the bit is on, we will look for that task in the queue and modify accordingly. It will also tell us where the data is temporarily stored. Every time that a verification task is created, the corresponding bit may have to be updated in the table. This bit may be a scrubbing flag.

Additionally, writing to a specific partition may cause damage in the partition that immediately precedes or immediately follows (on the disk), the specific partition. Thus, in an alternative exemplary embodiment, creating a task for a given partition also creates a task for the preceding partition and/or the following partition. The preceding partition and the following partition may be identified by the partition table. In this situation, the data corresponding to the preceding/following partition may not be in a cache, and therefore the verification may be just to attempt to read the data from the media, or issue a “verify” command. In the event there is a problem, then the correct data may be brought from an alternate location. The alternative location may be identified by the partition table.

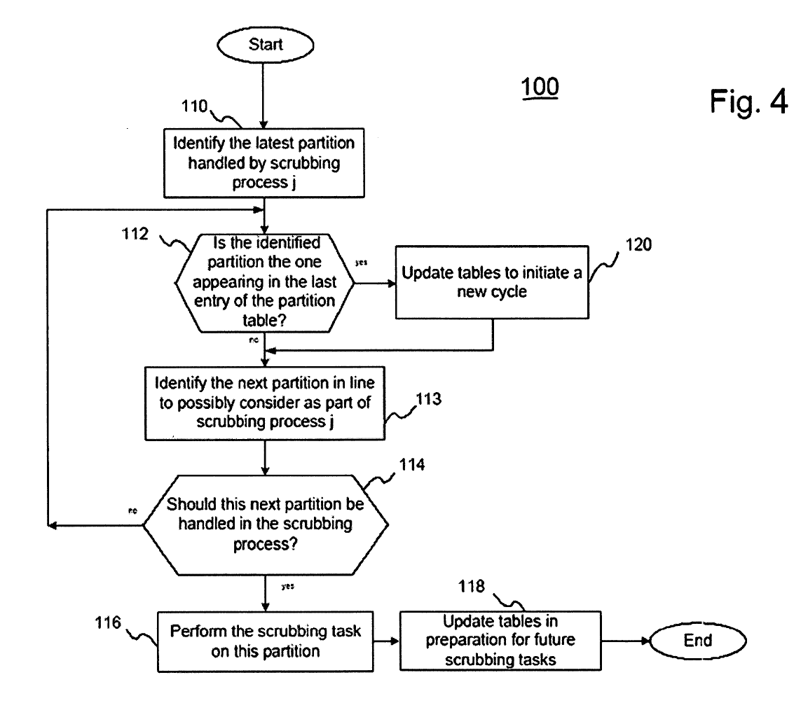

FIG. 4 is a schematic flowchart of an algorithm 150 showing steps performed in controller 20, according to an embodiment of the present invention. The flow proceeds from the start to action 110, which indicates to identify the latest partition handled by scrubbing process j. From action 110, the flow proceeds to query 112, which asks whether the identified process is the partition appearing in the last entry of the partition table. If the answer to query 112 is in the affirmative, then the flow proceeds to action 120, which indicates to update tables to initiate a new cycle. From action 120, the flow proceeds to action 113, which indicates to identify the next partition in line to consider as part of the scrubbing process j. If the answer to query 112 is in the negative, then the flow proceeds to action 113. From action 113, the flow proceeds to query 114, which asks whether the next partition should be handled in the scrubbing process. If the answer to query 114 is in the affirmative, then the flow proceeds back to query 112. If the answer to query 114 is in the negative, then the flow proceeds to action 116, which indicates to perform the scrubbing task on this partition. From action 116, the flow proceeds to action 118, which indicates to update tables in preparation for future scrubbing tasks. From action 118, the flow proceeds to the end.

Defining a verification task may be followed by the formation of a verification queue. Alternatively, a newly created verification task may be added to an already existing verification queue. Verification queues may be managed based on various schemes. The queue may be managed by an algorithm such as LRU (last recently used), MRU (most recently used), LIFO (last in first out) or FIFO (first in first out). Queue management algorithms may determine where to add the new task to the queue. Usually the new task is added to the end or tail of the queue, but alternative methods are possible, for instance adding to the middle or at a random position in the queue.

Another queue management issue addresses how to determine which verification task should be performed at any given moment. The queue is managed so that when the time comes to execute a verification task, the queue identifies which task to perform. Each verification task may have a timestamp which may be useful as part of the handling of the queue.

The appropriate time for executing a verification task may be decided by the main controller module 204 as part of the overall handling of the cache. The cache may be a disk controller and may have many demands made upon it from various systems, and may also have many tasks to perform. An exemplary embodiment of the present invention may determine the appropriate prioritization of the execution of a verification task according to a general overview of the system, and not necessarily because the partition has just been written. For instance, if the demands on the cache are momentarily high, then tasks like reading from and/or writing to the disk may be prioritized, and the verification task may be postponed. On the other hand, if there are many verification tasks in the queue that need to be performed, the cache may determine that completing verification tasks should be given priority. Additionally, the temporarily stored data may occupy precious cache space, which may weigh in favor of performing the verification tasks.

The prioritization of verification tasks may be made based on the kind of task to be executed by the cache. Additionally, the prioritization may be made based on and/or account for additional parameters for modifying the prioritization. These additional parameters may include: a maximal length of the queue, above which verification tasks may be immediately executed; a maximal time of the oldest verification task (as determined from a time stamp); a maximal value for the average times of tasks in the queue; a maximal time elapsed since the most recent verification task; etc.

An exemplary embodiment of the present invention may include writing data to a partition and verifying the data after some delay. Therefore, the present invention may include a type of scrubbing that, instead of checking all partitions in the system, addresses only partitions that have been modified recently and/or partitions that are proximate (e.g. either preceding or succeeding) to partitions that have been modified recently.

In an alternative exemplary embodiment of the present invention, a verification task is not created at the time of writing the data from cache to disk, but a flag or other indicator is associated with the data partition indicating that it requires verification. This write verification method may use a polling algorithm for selecting verification tasks. In this manner, the verification task is created after a delay from the write operation, either immediately before the verification task is performed, or before another delay before the verification task is performed.

For instance, a partition that has been written is marked in some manner so that at some later point in time (e.g., when the demands on the cache are reduced), some or all partitions may be scanned to determine which partitions are marked. When a marked partition is found, then a verification task may be created and/or executed for that partition. Therefore, the verification task need not be defined at the time of the write operation, but may be defined at some later point in time and/or immediately prior to execution. Thus, the queue may be of partitions to be verified and the particular verification task may be created at some later point in time.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

We claim:

1. A method for ensuring integrity of a data portion written by a controller and stored on a disk drive, the method comprising:
forming at least one queue of a plurality of verification tasks associated with the disk drive;
executing at least one verification task associated with the data portion in accordance with the queue; and
identifying each datum of the data portion as one of faulty and not faulty in accordance with the verification task.

2. The method according to claim 1, further comprising:
writing the data portion from a cache to the disk drive; and
repairing each datum identified as faulty.

3. The method according to claim 1, further comprising temporarily storing the data portion in a memory buffer.

4. The method according to claim 3, wherein the memory buffer is at least one of:
part of the disk controller; and
part of a cache memory of a storage system.

5. The method according to claim 3, further comprising erasing the data portion temporarily stored in the memory buffer after performing the verification task.

6. The method according to claim 3, wherein the repairing operation comprises at least one of:
taking no action;
issuing a message to a user or to a system manager indicating that a fault has been identified;
rewriting the data portion on the disk drive with the data portion temporarily stored in the memory buffer; and
overwriting the data portion with a further data portion obtained from one or more alternative locations.

7. The method according to claim 1, further comprising defining the at least one verification task.

8. The method according to claim 7, wherein the verification task comprises at least one of:
issuing a verify command for the data portion on the disk drive;
reading the data portion from the disk drive at the location where it was written;
sending a read request to an alternative location for a corresponding data portion in a system in communication with the controller;
comparing the data portion in the disk drive with the corresponding data portion in the alternative location;
reading meta-data associated with the data portion and verifying data sanity in the data portion in accordance with the metadata;
reading further meta-data associated with the corresponding data portion in the alternative location and verifying data sanity in the data portion in accordance with the further metadata; and
comparing metadata associated with the data portion in the disk drive with the further metadata associated with the corresponding data portion in the alternative location.

9. The method according to claim 1, further comprising:
acknowledging the completion of the write request;
wherein the verification task is executed substantially after the acknowledging operation.

10. The method according to claim 1, wherein the at least one queue is formed according to one of a scheme of:
first in first out (FIFO);
last in first out (LIFO);
last recently used (LRU);
most recently used (MRU); and
random access.

11. The method according to claim 1, further comprising managing the at least one queue, wherein the at least one queue is managed by:
performing the at least one verification task before a maximum time elapses since the verification task was added to the queue;
performing the at least one verification task after a minimum time elapses since the verification task was added to the queue;
performing the at least one verification task when the disk controller determines there is a low demand for high priority read/write tasks;
performing the at least one verification task when the disk controller determines an optimal time is reached based on a system demand overview;
performing the at least one verification task when the at least one queue is a maximal length;
performing the at least one verification task when a time stamp for the verification task exceeds a maximal time;
performing the at least one verification task when an average time to perform a plurality of performed verification tasks in the queue exceeds a maximal value; and
performing each verification task a maximal value of the most recent verification task.

12. The method according to claim 1, wherein the identifying operation comprises at least one of:
inability to read the data portion from the disk drive;
inability to read the data portion from the disk drive within a given time limit;
disagreement between the data portion read and a corresponding data portion read from an alternative location;
disagreement between metadata associated with the data portion and the data portion;
disagreement between the metadata associated with the data portion and further metadata associated with the corresponding data portion from the alternative location; and
disagreement between two or more data instances of the corresponding data portion from the alternative location.

13. A data storage apparatus, comprising:
a storage media adapted to store data;
a source media adapted to read data; and
a controller adapted to receive write commands, read data from the source media, and write data to the storage media;
wherein the controller is adapted to manage at least one queue of a plurality of verification tasks, each of the verification tasks associated with a data portion read from the source media and written to the storage media;
wherein the controller is adapted to execute each verification task associated with the data portion in accordance with the queue; and
wherein the controller is adapted to identify each datum of the data portion as one of faulty and not faulty in accordance with the verification task.

14. The data storage apparatus of claim 13, wherein the controller is adapted to repair each datum identified as faulty.

15. A device adapted to execute a method for ensuring integrity of data written by a controller and stored on a disk drive, the device comprising:
a managing arrangement adapted to manage at least one queue associated with the disk drive, the queue including a plurality of verification tasks, each verification task being associated with a data portion of the data;
a performing arrangement adapted to perform each verification task in accordance with the queue;
an identifying arrangement adapted to identify each datum of the data portion as one of faulty and not faulty in accordance with the verification task; and
a repairing arrangement adapted to repair each datum identified as faulty.

16. A computer-readable storage medium containing a set of instructions for a computer, the set of instructions comprising:
managing at least one queue associated with the disk drive, the queue including a plurality of verification tasks, each verification task being associated with a data portion;
performing the verification task associated with the data portion in accordance with the queue;
identifying each datum of the data portion as one of faulty and not faulty in accordance with the verification task; and
repairing each datum identified as faulty.

17. A method for ensuring integrity of a data portion written by a controller and stored on a disk drive, the method comprising:
flagging with at least one scrubbing flag at least one data partition of the disk drive;
scanning the disk drive for the scrubbing flags;
assigning at least one verification task to the data partition flagged with the scrubbing flag;
executing the verification task assigned to the data partition; and
identifying each datum of the data portion as one of faulty and not faulty in accordance with the verification task.

18. The method according to claim 17, further comprising:
writing the data portion from a cache to the data partition; and
repairing each datum identified as faulty.

19. The method according to claim 17, wherein the scanning is performed at least one of:
at regular intervals of time;
after writing a predetermined amount of data; and
after writing a predetermined number of write operations.

20. The method according to claim 17, wherein:
the scrubbing flag includes a verification task indicator; and
the assigning operation includes reading the verification task indicator and assigning the verification task based on the verification task indicator.
